(19) United States
(12) Patent Application Publication
(10) Pub. No.: US 2024/0340574 A1
(43) Pub. Date: Oct. 10, 2024

(54) Resonator and Audio Device

(71) Applicant: YAMAHA CORPORATION, Hamamatsu-shi (JP)

(72) Inventors: Azumi YOSHIDA, Hamamatsu-shi (JP); Hiroaki YAKUSHIDO, Hamamatsu-shi (JP)

(21) Appl. No.: 18/748,192

(22) Filed: Jun. 20, 2024

Related U.S. Application Data
(63) Continuation of application No. PCT/JP2022/040702, filed on Oct. 31, 2022.

(30) Foreign Application Priority Data
Dec. 21, 2021 (JP) 2021-206825

(51) Int. Cl. H04R 1/28

(52) U.S. Cl. CPC H04R 1/28

(57) ABSTRACT

A resonator includes a first resonance portion, a second resonance portion, and a communication portion. The first resonance portion includes a first housing which includes a first space and on which a first opening portion configured to communicate the first space with outside is formed. The second resonance portion includes a second housing which includes a second space and on which a second opening portion configured to communicate the second space with the outside is formed. The communication portion is configured to connect the first resonance portion with the second resonance portion to communicate with each other. A resonance frequency of the first resonance portion and a resonance frequency of the second resonance portion are identical to each other.

### CROSS-REFERENCE TO RELATED APPLICATIONS

The present application is a continuation application of International Application No. PCT/JP2022/040702, file Oct. 31, 2022, which claims priority to Japanese Patent Application No. 2021-206825, filed Dec. 21, 2021. The contents of these applications are incorporated herein by reference in their entirety.

### BACKGROUND

The present disclosure relates to a resonator and an audio device.

In an audio device such as a speaker, there is a known technique of eliminating or reducing a standing wave generated inside a housing with use of a resonator. For example, in a speaker disclosed in JP 2013-70362 A, a letter J-shaped resonance tube having openings at both ends is disposed in a speaker housing. Here, the tube length of the resonance tube is the same with the height of the speaker housing, one opening end is positioned in the vicinity of a top surface or a bottom surface of the speaker housing, and the other opening end is positioned in the vicinity of the middle in height of the speaker housing.

In the conventional technique described above, by the way, for example, in a case where a standing wave in a height direction and a standing wave in a depth direction are eliminated or reduced as in JP 2013-70362 A, two resonance tubes are needed for the respective standing waves, and there is a problem in that it becomes difficult to design the audio device.

An object of the present disclosure is to provide technical means for eliminating or reducing a plurality of types of standing waves generated in a housing with use of a small number of resonators.

### SUMMARY

One aspect is a resonator including a first resonance portion, a second resonance portion, and a communication portion. The first resonance portion includes a first housing which includes a first space and on which a first opening portion configured to communicate the first space with outside is formed. The second resonance portion includes a second housing which includes a second space and on which a second opening portion configured to communicate the second space with the outside is formed. The communication portion is configured to connect the first resonance portion with the second resonance portion to communicate with each other. A resonance frequency of the first resonance portion and a resonance frequency of the second resonance portion are identical to each other.

Another aspect is an audio device including a speaker housing and a resonator. The speaker housing is configured to support a speaker unit. The resonator is disposed in the speaker housing. The resonator includes a first resonance portion, a second resonance portion, and a communication portion. The first resonance portion includes a first housing which includes a first space and on which a first opening portion configured to communicate the first space with outside is formed. The second resonance portion includes a second housing which includes a second space and on which a second opening portion configured to communicate the second space with the outside is formed. The communication portion is configured to connect the first resonance portion with the second resonance portion to communicate with each other. A resonance frequency of the first resonance portion and a resonance frequency of the second resonance portion are identical to each other.

A more complete appreciation of the present disclosure and many of the attendant advantages thereof will be readily obtained as the same becomes better understood by reference to the following detailed description when considered in connection with the following figures, in which:

### BRIEF DESCRIPTION OF DRAWINGS

FIG. 1 is a cross-sectional view of a resonator according to an embodiment, illustrating a basic configuration of the resonator;

FIG. 2 is a cross-sectional view of the resonator, illustrating a configuration of the resonator that serves as the basis of a first specific example in the embodiment;

FIG. 3 is a cross-sectional view of the resonator, illustrating a primary resonance state of the resonator that serves as the basis;

FIG. 4 is a cross-sectional view of the resonator, illustrating a secondary resonance state of the resonator that serves as the basis;

FIG. 5 is a cross-sectional view of a primary resonance state in the first specific example;

FIG. 6 is a cross-sectional view of a secondary resonance state in the first specific example;

FIG. 7 is a cross-sectional view of a resonator, illustrating a configuration of the resonator that serves as the basis of a second specific example in the embodiment;

FIG. 8 is a cross-sectional view of a configuration in the second specific example;

FIG. 9 is a cross-sectional view of a resonator, illustrating a configuration of the resonator that serves as the basis of a third specific example in the embodiment;

FIG. 10 is a cross-sectional view of a configuration in the third specific example;

FIG. 11 is a side view of a speaker, illustrating a configuration of the speaker as an example of an audio device including the resonator;

FIG. 12 is a cross-sectional view according to another embodiment in the first specific example;

FIG. 13 is a cross-sectional view according to another embodiment in the first specific example;

FIG. 14 is a cross-sectional view according to another embodiment in the second specific example;

FIG. 15 is a cross-sectional view according to another embodiment in the second specific example; and

FIG. 16 is a cross-sectional view according to another embodiment in the third specific example.

### DETAILED DESCRIPTION

The present specification is applicable to a resonator and an audio device.

The embodiments will now be described with reference to the accompanying drawings, wherein like reference numerals designate corresponding or identical elements throughout the various drawings. The embodiments presented below serve as illustrative examples of the present disclosure and are not intended to limit the scope of the present disclosure.

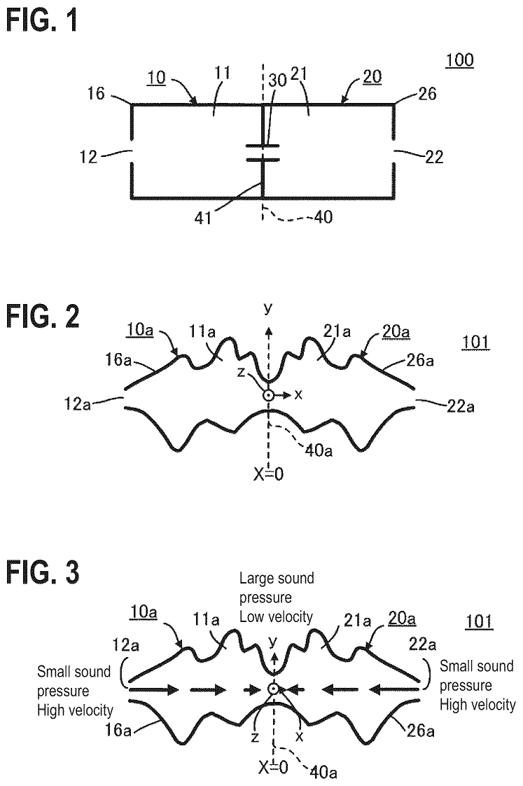

FIG. 1 is a cross-sectional view of a resonator 100 according to an embodiment, illustrating a basic configuration of the resonator 100. The resonator 100 includes a first resonance portion 10 and a second resonance portion 20. Here, the first resonance portion 10 includes a first housing 16, which includes a first space 11, and on which a first opening portion 12 for communicating the first space 11 with the outside is formed. In addition, the second resonance portion 20 includes a second housing 26, which includes a second space 21, and on which a second opening portion 22 for communicating the second space 21 with the outside is formed. The resonator 100 is plane-symmetric with respect to a symmetry plane 40, which is a virtual plane. In the resonator 100, a wall 41, which forms a boundary between the first resonance portion 10 and the second resonance portion 20, is provided along the symmetry plane 40. A communication portion 30 is, for example, a hollow cylindrical member, and penetrates through the wall 41. The communication portion 30 is continuous so that the first resonance portion 10 and the second resonance portion 20 communicate with each other. In addition, in the resonator 100, the resonance frequency of the first resonance portion 10 is identical to the resonance frequency of the second resonance portion 20.

In the resonator 100 according to the present embodiment, the resonance frequency of the first resonance portion 10 and the resonance frequency of the second resonance portion 20 are identical to each other. Thus, when primary resonance is generated in the resonator 100, no air particle moves between the first resonance portion 10 and the second resonance portion 20 through the communication portion 30. For this reason, the communication portion 30 does not affect the primary resonance frequency of the resonator 100. On the other hand, when secondary resonance is generated in the resonator 100, air particles move between the first resonance portion 10 and the second resonance portion 20 through the communication portion 30. Hence, by changing the configuration of the communication portion 30, it becomes possible to change the secondary resonance frequency without changing the primary resonance frequency of the resonator 100. It is to be noted that this operation will be described in detail below in specific examples.

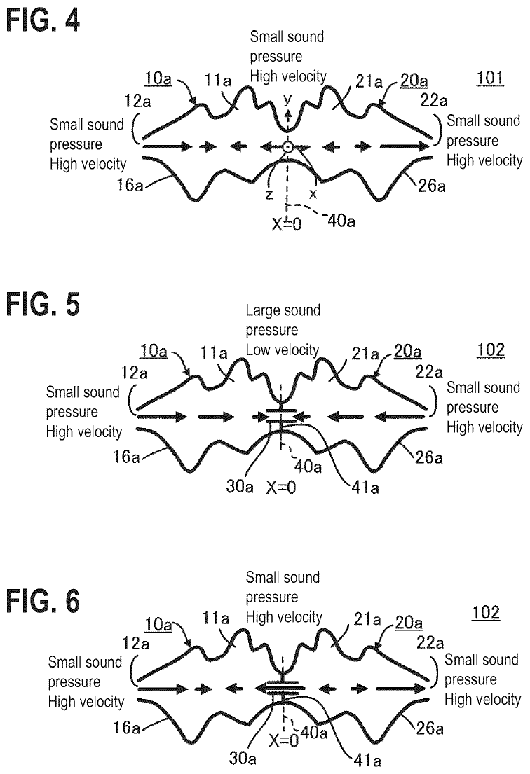

FIG. 2 is a cross-sectional view of a resonator 101, illustrating a configuration of the resonator 101, which serves as the basis of the resonator 100 according to the present embodiment. The resonator 101 includes a first resonance portion 10a, and a second resonance portion 20a. The first resonance portion 10a includes a first housing 16a, which includes a first space 11a, and on which a first opening portion 12a for communicating the first space 11a with the outside is formed. The second resonance portion 20a includes a second housing 26a, which includes a second space 21a, and on which a second opening portion 22a for communicating the second space 21a with the outside is formed. The resonator 101 is plane-symmetric with respect to a symmetry plane 40a. In the following, an xyz orthogonal coordinate system having an origin at the boundary between the first resonance portion 10a and the second resonance portion 20a is assumed, and the resonator 101 will be described. Here, x-axis is an axis directed from the first resonance portion 10a toward the second resonance portion 20a in FIG. 2, and y-axis and z-axis are orthogonal to each other, and are also orthogonal to x-axis. Similar orthogonal coordinate systems are also illustrated respectively in FIGS. 3 and 4.

In FIG. 2, in a case where ϕ (x, y, z, t) represents a velocity potential at an optional position (x, y, z) in the resonator 101 and at an optional time t, equations of wave motion expressed in the following mathematical formulae are established at the optional position (x, y, z) in the resonator 101.

$$\begin{matrix}\frac{{\partial }^{2} ϕ}{\partial {x}^{2}} + \frac{{\partial }^{2} ϕ}{\partial {y}^{2}} + \frac{{\partial }^{2} ϕ}{\partial {z}^{2}} = \frac{1}{{c}^{2}} \frac{{\partial }^{2} ϕ}{\partial {t}^{2}} & ( 1.1 ) \\ p = ρ \frac{\partial ϕ}{\partial t} & ( 1.2 ) \\ {v}_{x} = - \frac{\partial ϕ}{\partial x} , {v}_{y} = - \frac{\partial ϕ}{\partial y} , {v}_{z} = - \frac{\partial ϕ}{\partial z} & ( 1.3 )\end{matrix}$$

In mathematical formulae (1.1) to (1.3), c represents sound velocity, ρ represents sound pressure, ρ represents volume density of air particles, and Vₓ, V_{y}, and V_{z} respectively represent velocities of the air particles in x direction, y direction, and z direction.

A boundary condition that the velocity of an air particle is zero on the symmetry plane 40a is applied to the equation of wave motion, as expressed in the following mathematical formula.

$$- \frac{\partial ϕ}{\partial x} {\vert}_{x = 0} = 0 \qquad ( 2 )$$

In this case, the velocity potential ϕ (x, y, z, t), which is the solution of the following differential equation, is generated inside the resonator 101, and thus an equation of wave motion, to which the boundary condition is applied, is established.

$$\frac{\partial ϕ ( x , y , z , t )}{\partial x} = - \frac{\partial ϕ ( - x , y , z , t )}{\partial x} \qquad ( 3 )$$

The velocity potential ϕ (x, y, z, t), which is the solution of the above mathematical formula (3), represents a velocity potential distributed in a plane-symmetric manner on the symmetry plane 40a (x=0). FIG. 3 is a view of the resonator 101, illustrating a state in which the velocity potential is distributed. As illustrated in FIG. 3, an equation of wave motion, to which the boundary condition of mathematical formula (2) is applied, is established in a primary resonance state in which an antinode of a particle velocity standing wave (small sound pressure, high velocity) is located on the first opening portion 12a, an antinode in an opposite phase of the particle velocity standing wave (small sound pressure, high velocity in an opposite direction) is located on the second opening portion 22a, and a node of the particle velocity standing wave (large sound pressure, low velocity) is located on the symmetry plane 40a.

Next, a boundary condition that the sound pressure is zero on the symmetry plane 40a as illustrated in the following mathematical formula is applied to the above equation of wave motion (1.1).

$$ρ \frac{\partial ϕ}{\partial t} {\vert}_{x = 0} = 0 \qquad ( 4 )$$

In this case, the velocity potential ϕ (x, y, z, t), which satisfies the following mathematical formula, is generated in the resonator 101, and thus an equation of wave motion, to which such a boundary condition is applied, is established.

$$ϕ ( x , y , z , t ) = - ϕ ( - x , y , z , t ) \qquad ( 5 )$$

The mathematical formula (5) means the velocity potential ϕ (x, y, z, t), which is distributed to be oppositely symmetric with respect to the symmetry plane 40a (x=0). FIG. 4 is a view of the resonator 101, illustrating a state in which such a velocity potential is distributed.

As illustrated in FIG. 4, an equation of wave motion, to which the boundary condition of mathematical formula (4) is applied, is established in a secondary resonance state in which an antinode of a particle velocity standing wave (small sound pressure, high velocity) is located on the first opening portion 12a, an antinode in an identical phase of the particle velocity standing wave (small sound pressure, high velocity in the same direction) is located on the second opening portion 22a, and an antinode in an opposite phase of the particle velocity standing wave (small sound pressure, high velocity in the opposite direction) is located on the symmetry plane 40a.

As described above, in the primary resonance state, no air particle moves between the first resonance portion 10a and the second resonance portion 20a, whereas in the secondary resonance state, air particles move between the first resonance portion 10a and the second resonance portion 20a. In the present embodiment, such a situation is utilized to change the secondary resonance frequency without changing the primary resonance frequency of the resonator 101.

FIG. 5 is a cross-sectional view of a resonator 102, illustrating a configuration of the resonator 102 in a first specific example of the present embodiment. In the resonator 102, a wall 41a, which forms a boundary between the first resonance portion 10a and the second resonance portion 20a, is provided along the symmetry plane 40a, and a communication portion 30a, which has a hollow cylindrical shape, and which passes through the wall 41a, is provided in the resonator 101 illustrated in FIG. 2. The communication portion 30a is continuous so that the first resonance portion 10a and the second resonance portion 20a communicate with each other. Through the communication portion 30a, air particles are enabled to move between the first resonance portion 10a and the second resonance portion 20a.

In the resonator 102 illustrated in FIG. 5, in a case where the boundary condition that the particle velocity is zero on the symmetry plane 40a is applied to the equation of wave motion (mathematical formula (1.1)), an equation of wave motion is established when the velocity potential ϕ (x, y, z, t), which is the solution of the following differential equation, is generated in the resonator 101, in a similar manner to the configuration of FIG. 3 described above.

$$\frac{\partial ϕ ( x , y , z , t )}{\partial x} = - \frac{\partial ϕ ( - x , y , z , t )}{\partial x} \qquad ( 6 )$$

In this case, as illustrated in FIG. 5, the resonator 102 is in the primary resonance state in which an antinode of a particle velocity standing wave (small sound pressure, high velocity) is located on the first opening portion 12a, an antinode in an opposite phase of the particle velocity standing wave (small sound pressure, high velocity in the opposite direction) is located on the second opening portion 22a, and a node of the particle velocity standing wave (large sound pressure, low velocity) is located on the symmetry plane 40a. In such a primary resonance state, no air particle moves through the communication portion 30a, and thus the primary resonance frequency of the resonator 102 does not change from the primary resonance frequency of the resonator 101 illustrated in FIG. 3.

Next, in the resonator 102, the boundary condition that the sound pressure on the symmetry plane 40a is zero is applied to an equation of wave motion. In this case, as illustrated in FIG. 6, an equation of wave motion, to which the boundary condition is applied, is established in the secondary resonance state in which an antinode of a particle velocity standing wave (small sound pressure, high velocity) is located on the first opening portion 12a, an antinode in an identical phase of the particle velocity standing wave (small sound pressure, high velocity in the same direction) is located on the second opening portion 22a, and an antinode in an opposite phase of the particle velocity standing wave (small sound pressure, high velocity in the opposite direction) is located on the symmetry plane 40a. In such a secondary resonance state, air particles move between the first resonance portion 10a and the second resonance portion 20a through the communication portion 30a.

Here, it is assumed that Sₚ represents an opening area of the communication portion 30a, l represents an axial length, uₚ represents a location of the air particle in the communication portion 30a, and the communication portion 30a is divided into two equal parts by the symmetry plane 40a, the following equations of motion (7.1) and (7.2) are respectively established in a region on the right side and a region on a left side of the symmetry plane 40a in the communication portion 30a.

$$\frac{ρ {S}_{p} l}{2} \ddot{{u}_{p}} ≃ - {S}_{p} ρ \frac{\partial ϕ}{\partial t} {\vert}_{x = 0} \qquad ( 7.1 )$$

$$\frac{ρ {S}_{p} l}{2} \ddot{{u}_{p}} ≃ {S}_{p} ρ \frac{\partial ϕ}{\partial t} {\vert}_{x = 0} \qquad ( 7.2 )$$

Thus, by changing the opening area Sₚ and the axial length l of the communication portions 30a, it becomes possible to change the secondary resonance frequency without changing the primary resonance frequency of the resonator 102.

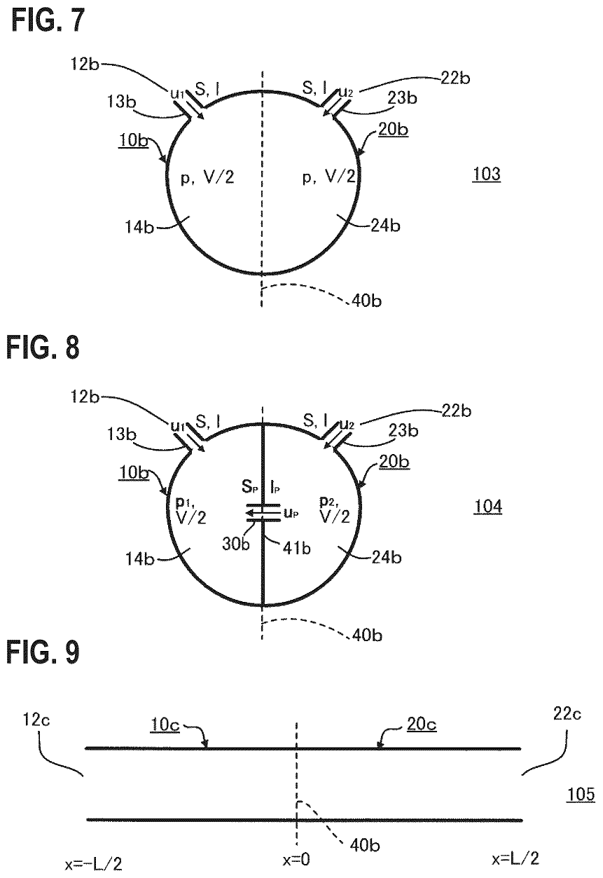

A second specific example in the present embodiment relates to a resonator in which the first resonance portion and the second resonance portion are each a Helmholtz resonator. FIG. 7 is a cross-sectional view of a resonator 103, illustrating a configuration of the resonator 103, which serves as the basis of the second specific example. The resonator 103 is plane-symmetric with respect to a symmetry plane 40b. The symmetry plane 40b is not a wall but a virtual plane. In the resonator 103, the first resonance portion 10b on the left side of the symmetry plane 40b includes a first housing. The first housing includes a neck 13b having a first opening portion 12b, and a cavity 14b, which is a first space. In addition, a second resonance portion 20b on the right side of the symmetry plane 40b includes a second housing. The second housing includes a neck 23b having a second opening portion 22b, and a cavity 24b, which is a second space. Here, the cavity 14b and the cavity 24b both have a cavity volume V/2. Further, the necks 13b and 23b both have a neck area S and a neck length l.

Under the boundary condition that the air particle velocity is zero on the symmetry plane 40b, the first resonance portion 10b and the second resonance portion 20b each include one neck, and each function as a Helmholtz resonator with a cavity volume V/2. In this case, in a case where u₁ and u₂ respectively represent locations of the air particles in the necks 13b and 23b of the two resonance portions, the sound pressure ρ in the cavity 14b of the first resonance portion 10b is given by the following mathematical formula. The same formula is also established in the second resonance portion 20b.

$$p = 2 ρ {c}^{2} \frac{S}{V} {u}_{1} \qquad ( 8 )$$

In addition, in the first resonance portion 10b, the following equation of motion is established. The same equation is also established in the second resonance portion 20b.

$$ρ Sl \ddot{{u}_{1}} = - Sp \qquad ( 9 )$$

Then, by substituting mathematical formula (8) into mathematical formula (9), the following mathematical formula is obtained.

$$\ddot{{u}_{1}} + 2 {c}^{2} \frac{S}{Vl} {u}_{1} = 0 \qquad ( 10 )$$

A resonance frequency f_{N} and resonance modes (U_{N1}, U_{N2}) that satisf_{N} mathematical formula (10) are expressed in the following mathematical formulae.

$${f}_{N} = \frac{1}{2 π} \sqrt{2} c \sqrt{\frac{S}{Vl}} \qquad ( 11.1 )$$

$$[ \begin{matrix}{u}_{N 1} \\ {u}_{N 2}\end{matrix} ] = [ \begin{matrix}1 \\ 1\end{matrix} ] \qquad ( 11.2 )$$

The mathematical formula (11.2) means that the antinodes in the identical phase of the particle velocity standing wave are respectively located in the first opening portion 12b and the second opening portion 22b.

Next, in a case where the sound pressure is zero on the symmetry plane 40b, the behaviors of the air particles in the neck 13b of the first resonance portion 10b follow the following equation of motion. The same equation is also established in the neck 23b of the second resonance portion 20b.

$$ρ Sl \ddot{{u}_{1}} = 0 \qquad ( 12 )$$

In this case, the resonance frequency f_{N} and the resonance modes (U_{N1}, U_{N2}) of the resonator 103 are expressed in the following mathematical formulae.

### Mathematical Formulae (13)

$${f}_{N} = 0 \qquad ( 13.1 )$$

$$[ \begin{matrix}{u}_{N 1} \\ {u}_{N 2}\end{matrix} ] = [ \begin{matrix}1 \\ - 1\end{matrix} ] \qquad ( 13.2 )$$

Mathematical formula (13.2) indicates that the resonator 103 is in a rigid body mode in which the particle velocity in the first opening portion 12b is transmitted to the second opening portion 22b without change.

FIG. 8 is a cross-sectional view of a resonator 104, illustrating a configuration of the resonator 104 in the second specific example of the present embodiment. In the resonator 104, a wall 41b is provided along the symmetry plane 40b, and a communication portion 30b, which penetrates through the wall 41b, is provided in the resonator 103 illustrated in FIG. 7. Similarly to the configuration of FIG. 7, the first resonance portion 10b on the left side of the symmetry plane 40b include the first housing. The first housing includes the neck 13b having the first opening portion 12b, and the cavity 14b, which is the first space. In addition, the second resonance portion 20b on the right side of the symmetry plane 40b includes the second housing. The second housing includes the neck 23b having the second opening portion 22b, and the cavity 24b, which is the second space. Similarly to the configuration of FIG. 7, the cavity 14b and the cavity 24b both have a cavity volume V/2. In addition, the necks 13b and 23b both have a neck area S and a neck length l. In the resonator 104, the communication portion 30b, which penetrates through the wall 41b, is a hollow cylindrical member having an opening area Sₚ and an axial length lₚ, and is divided into two equal parts by the symmetry plane 41b.

In a case where the velocity of an air particle that passes through the communication portion 30b is zero on the symmetry plane 40b, the first resonance portion 10b and the second resonance portion 20b each function as a Helmholtz resonator having one neck and a cavity volume V/2. In this case, the resonance frequency f_{N} and the resonance modes (u_{N1}, u_{N2}, u_{Np}) are given by the following mathematical formulae.

$${f}_{N} = \frac{1}{2 π} \sqrt{2} c \sqrt{\frac{S}{Vl}} \qquad ( 14.1 )$$

$$[ \begin{matrix}{u}_{N 1} \\ {u}_{N 2} \\ {u}_{Np}\end{matrix} ] = [ \begin{matrix}1 \\ 1 \\ 0\end{matrix} ] \qquad ( 14.2 )$$

The mathematical formula (14.2) means that the resonator 104 is in a primary resonance state in which antinodes in the identical phase of the particle velocity standing wave are respectively located in the first opening portion 12b and the second opening portion 22b, and a node of the particle velocity standing wave is located in the communication portion 30. Mathematical formula (14.1) indicates that even though the communication portion 30 is provided, the primary resonance frequency f_{N} does not change, as compared with a case where the communication portion 30 is not provided.

Next, in a case where the sound pressure is zero on the symmetry plane 40b, the first resonance portion 10b can be regarded as a Helmholtz resonator including the neck 13b having the neck area S and the neck length l, a neck having a neck area Sₚ and a neck length lₚ/2 (a half of the communication portion 30b), and the cavity 14b having a cavity volume V/2. Thus, the behaviors of air particles in the first resonance portion 10b follow the following equations of motion. The same equations are also established in the second resonance portion 20b.

$${p}_{1} = 2 ρ {c}^{2} \frac{S}{V} {u}_{1} + 2 ρ {c}^{2} \frac{{S}_{p}}{V} \qquad ( 15.1 )$$

$$ρ Sl \ddot{{u}_{1}} = - {Sp}_{1} , \qquad ( 15.2 )$$

$$\frac{ρ {S}_{p} {l}_{p}}{2} \ddot{{u}_{p}} = - {Sp}_{1}$$

By substituting mathematical formula (15.1) into mathematical formula (15.2), the following mathematical formula is obtained.

$$[ \begin{matrix}\ddot{{u}_{1}} \\ \ddot{{u}_{p}}\end{matrix} ] + 2 {c}^{2} \frac{S}{Vl} [ \begin{matrix}1 & \frac{{S}_{p}}{S} \\ \frac{2 Sl}{{S}_{p} {l}_{p}} & \frac{2 l}{{l}_{p}}\end{matrix} ] [ \begin{matrix}{u}_{1} \\ {u}_{p}\end{matrix} ] = [ \begin{matrix}0 \\ 0\end{matrix} ] \qquad ( 16 )$$

Two solutions are obtained as the solutions of mathematical formula (16). The first solution is the rigid body mode expressed in the following mathematical formulae.

$${f}_{N} = 0 \qquad ( 17.1 )$$

$$[ \begin{matrix}{u}_{N 1} \\ {u}_{N 2} \\ {u}_{Np}\end{matrix} ] = [ \begin{matrix}1 \\ - 1 \\ - 1\end{matrix} ] \qquad ( 17.2 )$$

The second solution of mathematical formula (16) is the secondary resonance expressed in the following mathematical formulae.

$${f}_{N} = \frac{1}{2 π} \sqrt{2} c \sqrt{\frac{S}{Vl} ( 1 + 2 \frac{l}{{l}_{p}} )} \qquad ( 18.1 )$$

Mathematical formula (18.1) indicates that the lengths lₚ of the communication portion 30b is involved in the secondary resonance frequency f_{N}. Therefore, in the resonator 104, by changing the length lₚ of the communication portion 30b, it becomes possible to change the secondary resonance frequency, without changing the primary resonance frequency.

A third specific example of the present embodiment relates to a resonator in which the first resonance portion 10 and the second resonance portion 20 are each a tube resonator. FIG. 9 is a cross-sectional view of a resonator 105, illustrating a configuration of the resonator 105, which serves as the basis of the third specific example. The resonator 105 is plane-symmetric with respect to the symmetry plane 40b. The symmetry plane 40b is not a wall but a virtual plane. In the resonator 105, a tube length and a tube cross-sectional area distribution in a tube length direction of the first resonance portion 10 are identical to a tube length and a tube cross-sectional area distribution in a tube length direction of a second resonance portion 20. To be specific, in the resonator 105, a first resonance portion 10c on the left side of the symmetry plane 40b is a straight tube resonator having a tube length L/2, and a second resonance portion 20c on the right side of the symmetry plane 40b is also a straight tube resonator having a tube length L/2.

In the resonator 105, the following equations of wave motion are established.

$$\frac{{\partial }^{2} ϕ}{\partial {x}^{2}} = \frac{1}{{c}^{2}} \frac{{\partial }^{2} ϕ}{\partial {t}^{2}} \qquad ( 19.1 )$$

$$p = ρ \frac{\partial ϕ}{\partial t} \qquad ( 19.2 )$$

$$v = - \frac{\partial ϕ}{\partial x} \qquad ( 19.3 )$$

Thus, the form of the solution of the equation of wave motion is assumed as follows.

$$ϕ = Φ ( x ) {e}^{j ω t} \qquad ( 20 )$$

By substituting mathematical formula (20) into mathematical formula (19.1), the following mathematical formula is obtained.

$$\frac{{\partial }^{2} Φ}{\partial {x}^{2}} + {k}^{2} Φ = 0 , \qquad ( 21 )$$

$$k = \frac{ω}{c}$$

The form of the solution of mathematical formula (21) is as follows.

$$Φ = {C}_{1} cos kx + {C}_{2} sin kx \qquad ( 22 )$$

The boundary condition that the particle velocity is zero on the symmetry plane 40b as expressed in the following mathematical formula is applied to the equation of wave motion of mathematical formula (21).

$$v {\vert}_{x = 0} = 0 , \qquad ( 23 )$$

$$p {\vert}_{x = \frac{L}{2}} = 0$$

In this case, the condition for the equation of wave motion to have a nontrivial solution is as expressed in the following mathematical formula.

$${C}_{2} = 0 , \qquad ( 24 )$$

$$k = \pm \frac{( 2 n - 1 ) π}{L}$$

Thus, the resonance frequency fₙ and the resonance mode Φₙ are expressed in the following mathematical formulae.

$${f}_{n} = \frac{2 n - 1}{2} \frac{c}{L} \qquad ( 25.1 )$$

$${Φ}_{n} = cos ( 2 n - 1 ) π \frac{x}{L} \qquad ( 25.2 )$$

In the above mathematical formulae (25.1) and (25.2), in a case where n=1, the resonance frequency and the resonance mode of the primary resonance are obtained.

Next, the boundary condition that the sound pressure is zero on the symmetry plane 40b as expressed in the following mathematical formula is applied to the equation of wave motion of mathematical formula (21).

$$p {\vert}_{x = 0} = 0 , \qquad ( 26 )$$

$$p {\vert}_{x = \frac{L}{2}} = 0$$

In this case, the condition for the equation of wave motion to have a nontrivial solution is as expressed in the following mathematical formula.

$${C}_{1} = 0 , \qquad ( 27 )$$

$$k = \pm \frac{2 n π}{L}$$

Thus, the resonance frequency fₙ and the resonance mode Φₙ are respectively expressed in the following mathematical formulae.

$${f}_{n} = n \frac{c}{L} \qquad ( 28.1 )$$

$${Φ}_{n} = sin 2 n π \frac{x}{L} \qquad ( 28.2 )$$

In the above mathematical formulae (28.1) and (28.2), in a case where n=1, the resonance frequency and the resonance mode of the primary resonance are obtained.

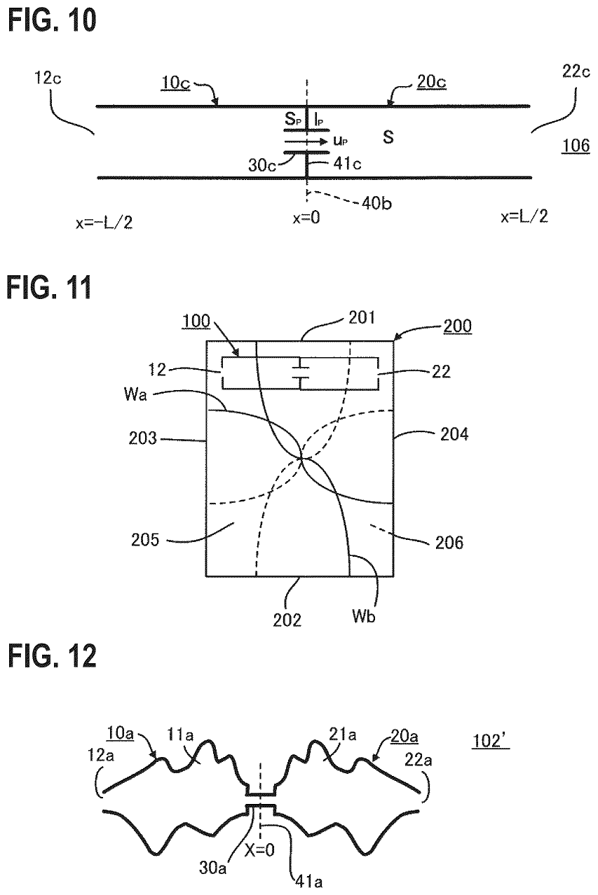

FIG. 10 is a cross-sectional view of a resonator 106, illustrating a configuration of the resonator 106 in a third specific example of the present embodiment. In the resonator 106, a wall 41c and a communication portion 30c are added to the resonator 105 of FIG. 9. Here, the wall 41c is provided along the symmetry plane 40b in the resonator 106. In addition, the communication portion 30c penetrates through the wall 41c. The communication portion 30c is a hollow tubular member having an opening area Sₚ and an axial length lₚ, and is divided into two equal parts by the symmetry plane 40b.

In a case where the boundary condition that the particle velocity is zero on the symmetry plane 40b is applied to the resonator 106, the resonance frequency and the resonance mode are as expressed in mathematical formulae (26.1) and (26.2) described above. That is, even though the communication portion 30c, which serves as a neck, is added, the primary resonance frequency does not change.

Next, it is assumed that the sound pressure is zero on the symmetry plane 40b. In this case, in the resonator 106, a neck having a neck area Sₚ and a neck length lₚ/2 (that is, a half of the communication portion 30c) is present on the symmetry plane 40b (x=0), and the sound pressure in an opening end of the neck can be regarded as zero. The behaviors of the air particles in this neck follow the equation of wave motion and boundary condition expressed in the following mathematical formulae.

$$\frac{ρ {S}_{p} {l}_{p}}{2} \ddot{{u}_{p}} = - Sp {\vert}_{x = 0} \qquad ( 29.1 )$$

$${S}_{p} \dot{{u}_{p}} = S v {\vert}_{x = 0} \qquad ( 29.2 )$$

$$p {\vert}_{x = \frac{L}{2}} = 0 \qquad ( 29.3 )$$

From these mathematical formulae, the form of a solution and a characteristic equation are obtained as expressed in the following mathematical formulae.

$$Φ = {C}_{2} sin k ( \frac{L}{2} - x ) \qquad ( 30.1 )$$

$$sin \frac{kL}{2} = \frac{1}{2} \frac{{l}_{p} S}{{S}_{p}} k cos \frac{kL}{2} \qquad ( 30.2 )$$

In the characteristic equation of mathematical formula (30.2), the solutions in a case where k>1 are set to k₁, k₂, . . . , the resonance frequency fₙ and the resonance mode Φₙ are expressed in the following mathematical formulae.

$${f}_{n} = \frac{c}{2 π} {k}_{n} \qquad ( 31.1 )$$

$$[ \begin{matrix}{Φ}_{n} {\vert}_{x > 0} \\ {Φ}_{n} {\vert}_{x < 0} \\ {u}_{np}\end{matrix} ] = [ \begin{matrix}sin {k}_{n} ( \frac{L}{2} - x ) \\ - sin {k}_{n} ( \frac{L}{2} + x ) \\ - j \frac{S}{{S}_{p}} \frac{1}{c} cos \frac{{k}_{n} L}{2}\end{matrix} ] \qquad ( 31.2 )$$

In mathematical formulae (31.1) and (31.2), in a case where n=1, the resonance frequency and the resonance mode of the secondary resonance are obtained. In the characteristic equation of mathematical formula (30.2), the axial length lₚ of the communication portion 30c is involved in the solution k₁. Thus, as the axial length lₚ of the communication portion 30c is changed, the resonance frequency of the secondary resonance is changed.

Heretofore, the first to third specific examples in the present embodiment have been described in detail.

FIG. 11 is a side view of a speaker 300, illustrating a configuration of the speaker 300, which is an example of an audio device including the resonator 100 according to the present embodiment. A speaker housing 200 of the speaker 300 is a housing having a rectangular parallelepiped shape surrounded by a top surface 201, a bottom surface 202, a front surface 203, a back surface 204, a right side surface 205, and a left side surface 206, which support a speaker unit 301.

In the example illustrated in FIG. 11, the top surface 201 and the bottom surface 202 respectively serve as first and second inner walls that interpose an internal space of the speaker housing 200, and the front surface 203 and the back surface 240 respectively serve as third and fourth inner walls that are orthogonal to the first and second inner walls and that interpose the space in common with the first and second inner walls. The resonator 100 is disposed such that the first opening portion 12 and the second opening portion 22 are respectively disposed on the first inner wall (top surface 201) in a position in the vicinity of the third inner wall (front surface 203) and in a position in the vicinity of the fourth inner wall (back surface 204). Here, in the vicinity of the inner wall denotes a range from the inner wall surface to a position separated by approximately 10% the wavelength of the standing wave to be eliminated or reduced.

FIG. 11 illustrates two types of standing waves generated in the speaker housing 200. One of them is a pressure standing wave Wa of the primary resonance generated between the first inner wall (top surface 201) and the second inner wall (bottom surface 202). Here, antinodes in opposite phases opposite to each other of the pressure standing wave Wa are respectively located on the first inner wall (top surface 201) and the second inner wall (bottom surface 202). The other one of them is a pressure standing wave Wb of the primary resonance generated between the third inner wall (front surface 203) and the fourth inner wall (back surface 204). Here, antinodes in opposite phases opposite to each other of the pressure standing wave Wb are respectively located on the third inner wall (front surface 203) and the fourth inner wall (back surface 202).

Pressure of the antinodes in identical phases identical to each other of the pressure standing wave Wa is applied to each the first opening portion 12 and the second opening portion 22 of the resonator 100. In addition, pressure of the antinodes in opposite phases opposite to each other of the pressure standing wave Wb is applied to each the first opening portion 12 and the second opening portion 22 of the resonator 100.

In FIG. 11, the frequency of the pressure standing wave Wa is identical to the primary resonance frequency of the resonator 100. In addition, the frequency of the pressure standing wave Wb is identical to the secondary resonance frequency of the resonator 100. Therefore, the resonator 100 is capable of eliminating or reducing both the pressure standing wave Wa and the pressure standing wave Wb.

Further, in the present embodiment, by changing the configuration of the communication portion 30 as described above, it becomes possible to change the secondary resonance frequency without changing the primary resonance frequency of the resonator 100. Thus, even in a case where the ratio of the distance between the first inner wall (top surface 201) and the second inner wall (bottom surface 202) to the distance between the third inner wall (front surface 203) and the fourth inner wall (back surface 204) is not a predetermined ratio, an adjustment to the communication portion 30 enables an adjustment to the primary resonance frequency and the secondary resonance frequency of the resonator 100, and eliminates or reduces both of two types of standing waves generated in the speaker housing 200.

As described heretofore, according to the present embodiment, with a small number of resonators, it becomes possible to eliminate or reduce a plurality of types of standing waves generated in the housing.

While one embodiment has been described above, other embodiments of the present invention are conceivable. Examples will be described in the following.

(1) In the examples illustrated in FIGS. 5 and 6, the communication portion 30a is provided in the resonator 102, and the communication portion 30a penetrates through the wall 41a, which forms the boundary between the first resonance portion 10a and the second resonance portion 20a. However, the configurations of the first resonance portion 10a, the second resonance portion 20a, and the communication portion 30a are not limited to this. For example, like a resonator 102′, as illustrated in FIG. 12, the first resonance portion 10a and the second resonance portion 20a may be separated from each other, and the communication portion 30a, which connects both resonance portions, may be provided.

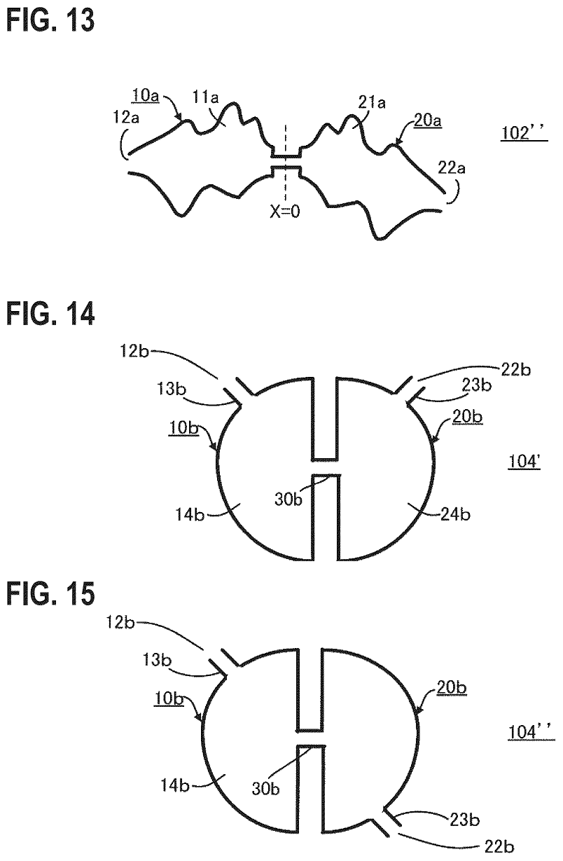

(2) In the examples illustrated in FIGS. 5 and 6, the resonator 102 is plane-symmetric with respect to the symmetry plane 40a. However, as long as the resonance frequencies of the first resonance portion 10a and the second resonance portion 20a are identical to each other, the resonator 102 may not be necessarily plane-symmetric with respect to the symmetry plane 40a. For example, like a resonator 102″, as illustrated in FIG. 13, the second resonance portion 20a may be bent relative to the first resonance portion 10a, or the second resonance portion 20a may be twisted relative to the first resonance portion 10a.

(3) A similar configuration is applied to a case where two resonance portions are both Helmholtz resonators. In the example illustrated in FIG. 8, the communication portion 30b is provided in the resonator 104, and the communication portion 30b penetrates through the wall portion 41b, which forms a boundary between the first resonance portion 10b and the second resonance portion 20b each serving as a Helmholtz resonator. However, for example, like a resonator 104′, as illustrated in FIG. 14, the first resonance portion 10b and the second resonance portion 20b may be separated from each other, and the communication portion 30a, which connects both resonance portions, may be provided.

(4) In the example illustrated in FIG. 8, the resonator 104 is plane-symmetric with respect to the symmetry plane 40b. However, as long as the resonance frequencies of the first resonance portion 10b and the second resonance portion 20b are identical to each other, the resonator 104 may not be necessarily plane-symmetric with respect to the symmetry plane 40a. For example, like a resonator 104″, as illustrated in FIG. 15, the neck 13b of the first resonance portion 10b and the neck 23b of the second resonance portion 20b may be located in positions that are not plane-symmetric. In addition, the cavity shape may be different between the first resonance portion 10b and the second resonance portion 20b.

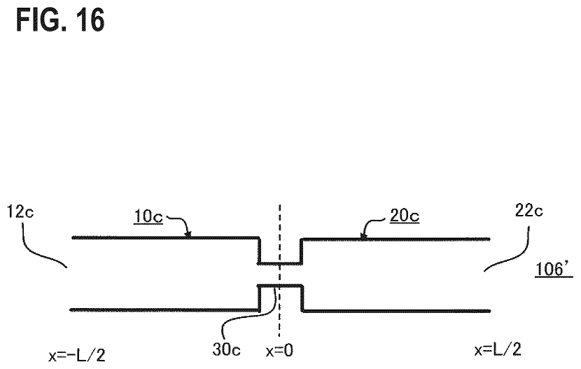

(5) In the example illustrated in FIG. 10, the communication portion 30c is provided in the resonator 106, and the communication portion 30c penetrates through the wall 41c, which forms the boundary between the first resonance portion 10c and the second resonance portion 20c each serving as a tube resonator. However, instead of such a configuration, for example, like a resonator 106′, as illustrated in FIG. 16, the first resonance portion 10c and the second resonance portion 20c may be separated from each other, and the communication portion 30c, which connects both resonance portions may be provided. In addition, the tube cross-sectional shape and/or the tube path (shape) may be different between the first resonance portion 10c and the second resonance portion 20c.

(6) In the above embodiments, one communication portion 30 is provided between the first resonance portion 10 and the second resonance portion 20. However, two or more communication portions 30 may be provided.

(7) In order to change the secondary resonance frequency without changing the primary resonance frequency of the resonator, in a strict sense, the following condition has to be satisfied. That is, between the first resonance portion and the second resonance portion, it is necessary to match the resonance frequencies of the primary resonance, the damping ratios, and pressure distributions on the symmetry plane for the volume velocity of air particles in opening ends of the first resonance portion and the second resonance portion in a case where the communication portion is not included, and to provide the communication portion in a position where the particle velocity in a tangential direction of the symmetry plane can be ignored.

Here, the “pressure distributions on the symmetry plane for the volume velocity of air particles in opening ends of the first resonance portion and the second resonance portion in a case where the communication portion is not included” will be described. In the case where the communication portion is not included, Φ_{N} (x, y, z) represents a velocity potential distribution of the primary resonance, D₀ represents an opening surface of the opening end, Dₘ represents a region of the symmetry surface, and no represents a normal direction vector of the opening surface, the volume velocity of the air particles on the opening surface is expressed in the following mathematical formula.

$$- \text{?} \frac{\partial {Φ}_{ℕ}}{\partial {n}_{o}} dS \qquad ( 32 )$$

$$\text{?} \text{indicates text missing or illegible when filed}$$

In a case where jρωΦ_{N} (x, y, z) (where x, y, and z are included in the region Dₘ) represents the pressure distribution on the symmetry plane, the “pressure distributions on the symmetry plane for the volume velocity of air particles in opening ends of the first resonance portion and the second resonance portion in a case where the communication portion is not included” is expressed in the following mathematical formula.

### Mathematical Formula (33)

$$- \frac{j ρ ω {Φ}_{ℕ} ( x , y , z )}{\text{?} \frac{\partial {Φ}_{ℕ}}{\partial {n}_{o}} dS} where x , y , and z are included in the region {D}_{m} \qquad ( 33 )$$

$$\text{?} \text{indicates text missing or illegible when filed}$$

In a case where the above pressure distributions are made to match between the first resonance portion and the second resonance portion, when the opening ends of the two resonance portions are excited with identical sound pressure, pressures are balanced in the vicinity of the symmetry plane, and the primary resonance is not affected, regardless of the presence or absence of the communication portion.

It is to be noted that regardless of whether the first resonance portion and the second resonance portion are Helmholtz resonators or tube resonators, in a case where the cross-sectional dimension on the symmetry plane (or the cross-sectional dimension of the opening of the communication portion) is smaller than the wavelength, it does not cause a problem, as long as the average values of the pressure in the pressure distributions match each other between the first resonance portion and the second resonance portion.

In addition, in a case where the cross-sectional dimension on the symmetry plane (or the cross-sectional dimension of the opening of the communication portion) is smaller than the wavelength of the first resonance wave, even though the communication portion is provided in the position where the particle velocity in a tangential direction of the symmetry plane cannot be ignored, it does not cause a problem.

What is claimed is:

1. A resonator comprising:
a first resonance portion including a first housing which includes a first space and on which a first opening portion configured to communicate the first space with outside is formed;
a second resonance portion including a second housing which includes a second space and on which a second opening portion configured to communicate the second space with the outside is formed; and
a communication portion configured to connect the first resonance portion with the second resonance portion to communicate with each other,
wherein a resonance frequency of the first resonance portion and a resonance frequency of the second resonance portion are identical to each other.

2. The resonator according to claim 1,
wherein the first resonance portion and the second resonance portion are each a Helmholtz resonator including a cavity and a neck, and
wherein a cavity volume, a neck length, and a neck area of the first resonance portion are respectively identical to a cavity volume, a neck length, and a neck area of the second resonance portion.

3. The resonator according to claim 1,
wherein the first resonance portion and the second resonance portion are each a tube resonator, and
wherein a tube length and a tube cross-sectional area distribution in a direction of the tube length of the first resonance portion are respectively identical to a tube length and a tube cross-sectional area distribution in a direction of the tube length of the second resonance portion.

4. An audio device comprising:
a speaker housing configured to support a speaker unit; and
a resonator disposed in the speaker housing,
wherein the resonator includes
a first resonance portion including a first housing which includes a first space and on which a first opening portion configured to communicate the first space with outside is formed,
a second resonance portion including a second housing which includes a second space and on which a second opening portion configured to communicate the second space with the outside is formed, and
a communication portion configured to connect the first resonance portion with the second resonance portion to communicate with each other, and
wherein a resonance frequency of the first resonance portion and a resonance frequency of the second resonance portion are identical to each other.

5. The audio device according to claim 4,
wherein the first opening portion and the second opening portion are disposed in two positions including: a position of an antinode in an identical phase to a pressure standing wave generated in the speaker housing and having an identical frequency to a primary resonance frequency of the resonator; and a position of an antinode in an opposite phase to a pressure standing wave generated in the speaker housing having an identical frequency to a secondary resonance frequency of the resonator.

6. The audio device according to claim 4,
wherein the speaker housing includes
first and second inner walls that interpose an internal space of the speaker housing, and
third and fourth inner walls that are orthogonal to the first and second inner walls and that interpose the internal space in common with the first and second inner walls, and
wherein the first opening portion and the second opening portion are respectively disposed on the first inner wall in a position in a vicinity of the third inner wall and in a position in a vicinity of the fourth inner wall.
